(19) United States
(12) Patent Application Publication
(10) Pub. No.: US 2026/0320932 A1
(43) Pub. Date: Oct. 15, 2026

(54) CONTENT REPROJECTION BETWEEN LOCATIONS

(71) Applicant: Apple Inc., Cupertino, CA (US)

(72) Inventor: Emmanuel Piuze-Phaneuf, Los Gatos, CA (US)

(21) Appl. No.: 19/640,920

(22) Filed: Apr. 7, 2026

Related U.S. Application Data
(60) Provisional application No. 63/788,885, filed on Apr. 15, 2025.

(51) Int. Cl. G06T 19/00; G06F 3/01; G06T 15/20; H04N 7/18; H04N 23/695

(52) U.S. Cl. CPC G06T 19/006; G06F 3/013; G06F 3/017; G06T 15/20; H04N 7/183; H04N 23/695; G06F 3/012

(57) ABSTRACT

Various implementations disclosed herein include devices, systems, and methods that enable a user at a first location to view reprojected content from a camera at a second location from a point of view of the user. For example, a process may present a first view from a first viewpoint within a first location within an environment. The first view may include an obstacle preventing the first view from including a portion of a second location within the environment. The process may further detect a triggering condition associated with viewing the second location and in response, the process may further present a second view of the environment generated based on image data captured from a second viewpoint within the second location.

### CROSS-REFERENCE TO RELATED APPLICATIONS

This Application claims the benefit of U.S. Provisional Application Serial No. 63/788,885 filed Apr. 15, 2025, which is incorporated herein in its entirety.

### TECHNICAL FIELD

The present disclosure generally relates to systems, methods, and devices that enable a user at a location to view reprojected content from a camera at a different location from a point of view of the user.

### BACKGROUND

Existing techniques for enabling a user to view content from a different location may be improved with respect to a realistic and accurate view to provide desirable viewing experiences.

### SUMMARY

Various implementations disclosed herein include devices, systems, and methods that enable a user at a first location to view reprojected content or images from a camera(s) at a second location from a point of view of the user as if the user is able to see through an obstacle into the second location. For example, a user located in a first room while wearing a wearable device such as a head mounted device (HMD) may be enabled to view reprojected content from a camera(s) in a second room adjacent to the first room as if the user is able to see through a wall into the second location.

In some implementations, a view of reprojected content or images from a camera(s) at a second location may be provided in an extended reality (XR) environment via a portal such as, for example, a virtual opening in a wall. In some implementations, an existing portal may be initialized or triggered by manually placing (e.g., dragging) the portal at a location such as a position on a wall in the XR environment. In some implementations, a portal may be initialized or triggered in response to user gaze directed towards a location such as a position on a wall in the XR environment. In some implementations, a portal may be initialized or triggered in response to a user gesture (e.g., hand gesture, a finger gesture, a head gesture, a facial expression, etc.) being performed with respect to a location such as a position on a wall in the XR environment.

In some implementations, a portal may be initialized (e.g., opened) slowly as a user engages with a portal or position on an obstacle such as a wall. In some implementations, a portal may be initialized instantaneously when a user engages with a portal or position on an obstacle such as a wall.

In some implementations, the aforementioned process may use a pose of an image sensor such as a camera with respect to a pose of a user using a viewing device (at a first location) such as an HMD to provide a line-of-sight view through a portal into the second location. In some implementations, a pose of an image sensor may be aligned with a point of view of the user by moving a position of the image sensor via, for example, use of a servo, use of a robotic device, etc.

In some implementations, an electronic device has a processor (e.g., one or more processors) that executes instructions stored in a non-transitory computer-readable medium to perform a method. The method performs one or more steps or processes. In some implementations, the electronic device presents via the one or more displays, a first view from a first viewpoint within a first location within an XR environment. The first view includes an obstacle preventing the first view from including a portion of a second location within the XR environment. The second location differs than the first location. In some implementations, a triggering condition associated with viewing the second location is triggered. In some implementations, it is determined that an alignment criterion is satisfied based on an orientation of an image sensor capable of capturing image data from a second viewpoint within the second location. In some implementations, based on determining that the alignment criterion is satisfied, a second view of the XR environment is presented such that the portion of the second location is included in the second view based on image data from the image sensor capturing image data from a second viewpoint within the second location.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIGS. 2A-2D illustrate views representing various configurations of a user view of an XR environment viewable via a display of a device such as an HMD, in accordance with some implementations.

FIG. 3 is a block diagram of an example system illustrating a user device configured to enable a user at a first location to view reprojected content or images from a camera(s) at a second location from a point of view of the user, in accordance with some implementations.

FIG. 4 is a flowchart representation of an exemplary method that enables a user at a first location to view from a point of view of the user, reprojected content or images from a camera at a second location as if the user is able to see through an obstacle into the second location, in accordance with some implementations.

FIG. 5 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

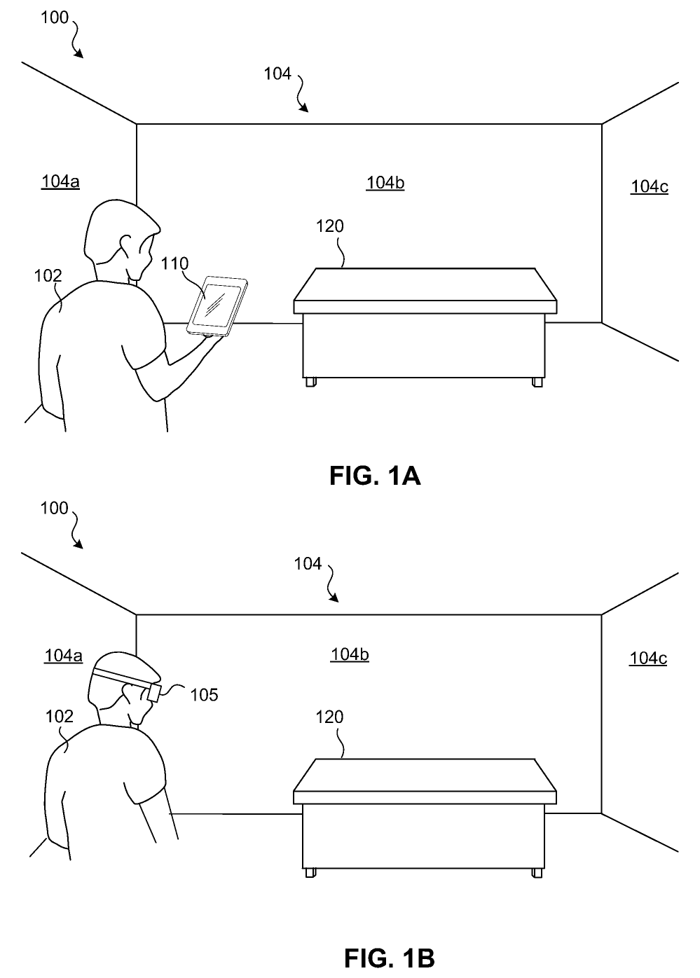

FIGS. 1A-B illustrate exemplary electronic devices 105 and 110 operating in a physical environment 100. In the example of FIGS. 1A-B, the physical environment 100 includes a room 104 that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an XR environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

Various implementations disclosed herein include devices, systems, and methods that implement gaze tracking approaches that use image data. In some implementations, gaze may be tracked using imaging data to determine eye position or eye orientation using a pupil plus glint model, using a depth camera (e.g., stereo, structured light projection, time-of-flight (ToF), etc.) with 3D point cloud registration, or using an appearance-based model.

In some implementations, device 105 and/or device 110 enable user 102 in, for example, room 104 to view reprojected images from a camera within a room adjacent to room 104 (e.g., a room on the other side of any of walls 104a…104c) as if the user is able to see through one of walls 104a…104c into the adjacent room. For example, a first view (e.g., of an XR environment presented via device 105 and/or device 110) from a first viewpoint (e.g., a viewpoint of device 105 and/or device 110) within room 104 may be presented to user 102. The first view may include an obstacle (e.g., walls 104a…104c) preventing the first view from allowing user 102 to view a portion of an adjacent room located on the other side of any of walls 104a…104c.

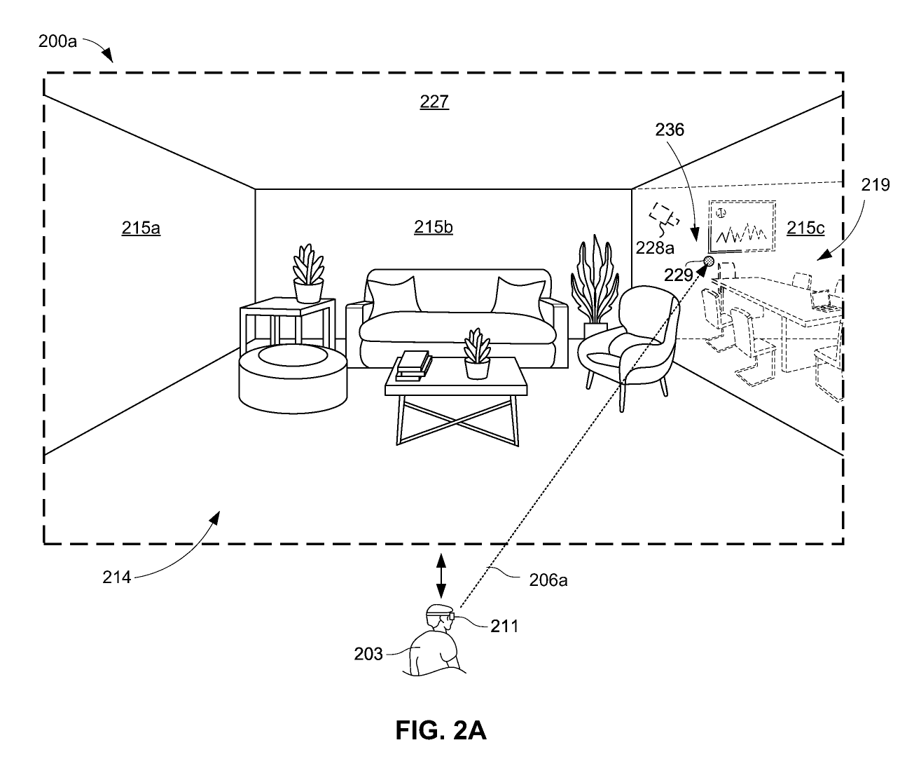

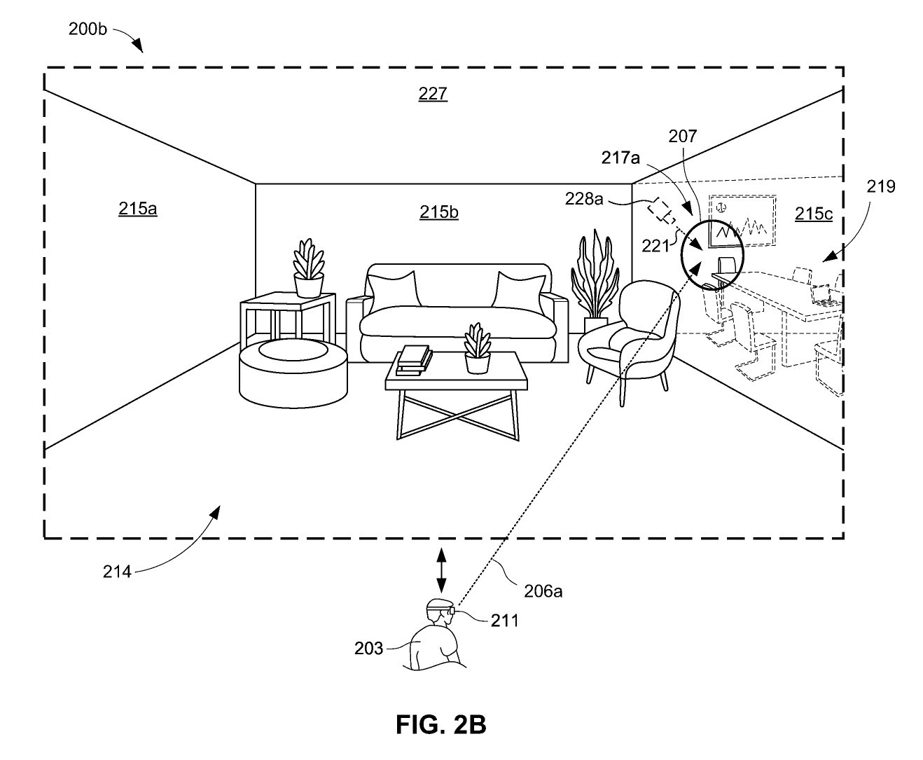

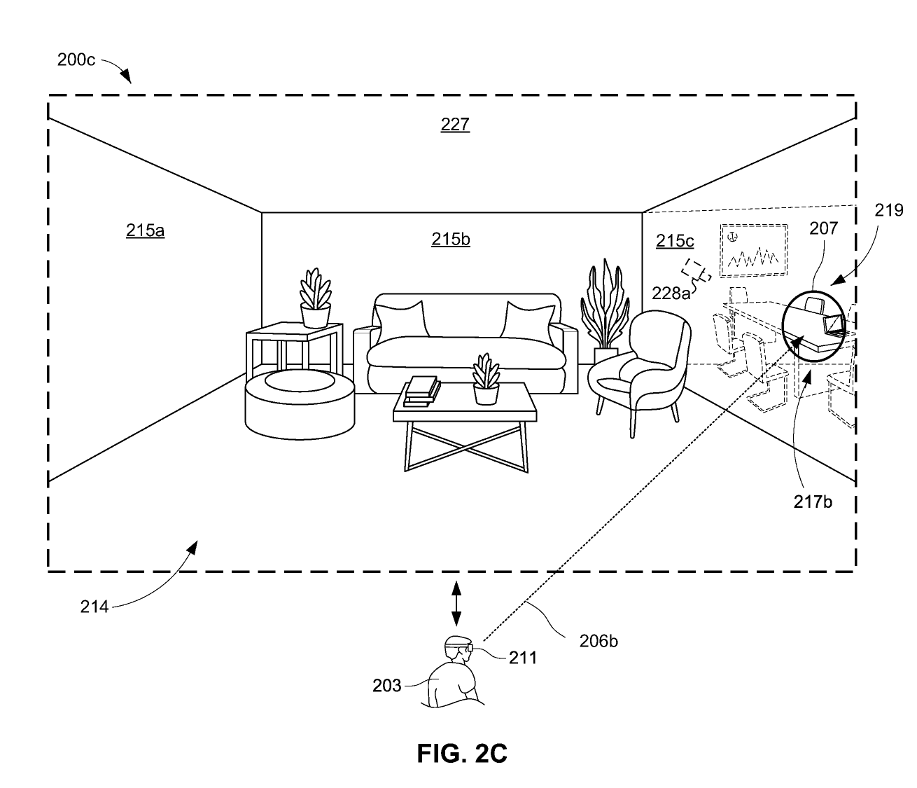

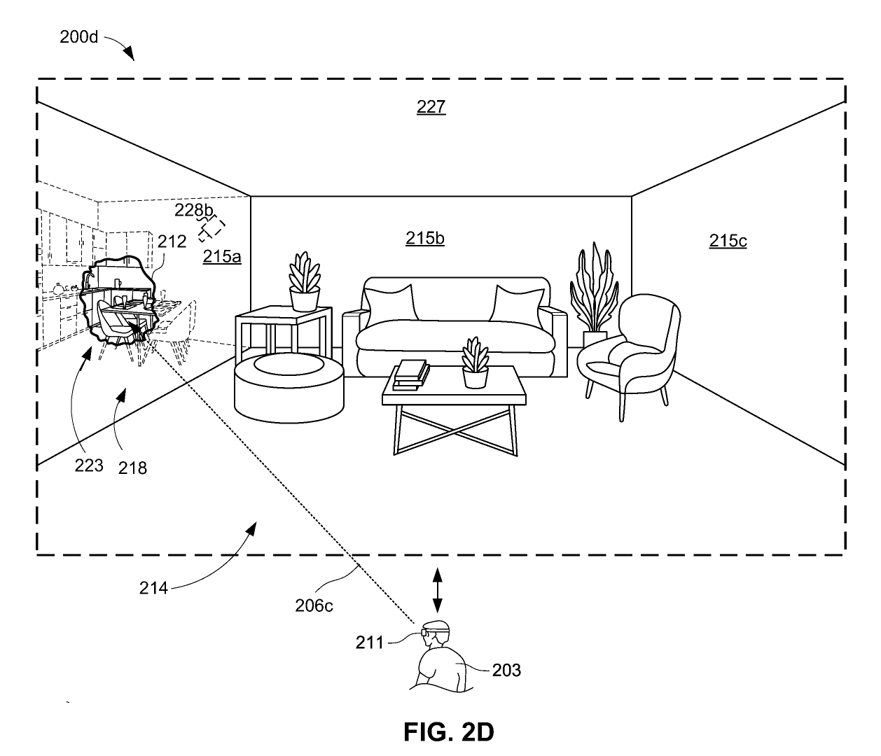

In some implementations, a triggering condition associated with viewing the adjacent room may be detected via sensor data obtained by sensors. For example, detecting a triggering condition may include determining that user 102 is looking or gesturing towards the adjacent room. Alternatively or additionally, detecting a triggering condition may include detecting that user 102 drags or moves a user interface element such as a portal (e.g., within an XR environment) to a viewing location (e.g., on one of walls 104a…104c) as described with respect to FIGS. 2A-2D, infra.

In some implementations, it may be determined that an alignment criterion is satisfied based on a determined orientation of an image sensor (e.g., a camera(s)) that is configured to capture image data from a second viewpoint within the adjacent room. For example, it may be determined that a camera in the adjacent room is sufficiently aligned in the same direction as device 105 and/or device 110 (e.g., viewpoints aligned) such that a realistic view (presented within an XR environment) of a specified quality level may be provided to user 102. A view of a specified quality level may include, inter alia, a view with: limited holes, limited hallucinations, limited reprojection errors, etc. In some implementations, a threshold angle difference between device 105 or 110 direction and a camera capture direction may be used to determine the specified quality level.

In some implementations, a second view of the XR environment may be presented to user 102 based on determining that the alignment criterion is satisfied. In some implementations, the portion of the adjacent room is included in the second view based on image data from the camera capturing image data from a second viewpoint within the adjacent room. For example, the portion of the adjacent room in the second view may generated by replacing a portion of a wall/obstacle with content obtained from the camera in the adjacent room. The content obtained from the camera in the adjacent room may be altered or reprojected to provide a view of the adjacent room that corresponds to the first viewpoint and not the second viewpoint. In some implementations, providing the second view may include providing an (virtual) opening or portal within the wall through which the second location is viewed.

FIGS. 2A-2D illustrate views 200a-200drepresenting various configurations of a user view of an XR environment 227 viewable via a display of a device 211 such as an HMD, in accordance with some implementations.

FIG. 2A illustrates view 200a representing XR environment 227 being viewed by user 203 via device 211. XR environment 227 includes a physical environment 214 (e.g., a first room such as a living room with furniture) with walls 215a, 215b, and 215c causing obstacles that prevent the viewing of content within other physical environments. For example, the user 203 may be located within physical environment 214 and wall 215c may create an obstacle with respect to viewing (by user 203) content within a physical environment 219 (e.g., a second room such as an office with a table). In some implementations, physical environment 219 includes an image sensor 228a such as, for example, a camera.

In some implementations, user 203 within physical environment 214 may want to observe objects within physical environment 219 (e.g., a computer, a TV, a table, a person such as a child, etc.) and accordingly the user 203 may trigger a view of a portion of physical environment 219 via a virtual opening or portal placed on wall 215c to provide a view (aligned with a point of view of user 203) of the portion of the physical environment 219 (e.g., reprojected content) as described, infra with respect to FIGS. 2B-2D.

In some implementations, a gesture/movement activated triggering mechanism may be enabled for activating a virtual opening (e.g., virtual opening 207 as illustrated in FIG. 2B) by enabling user 203 to use a gesture (e.g., a hand or finger gesture) to enable a virtual opening structure and place (e.g., dragging) the virtual opening structure at a specified location (e.g., at a specified location on a wall) for viewing another physical location (e.g., a room on the other side of a wall).

In some implementations, a gaze activated triggering mechanism may be enabled for activating a virtual opening (e.g., virtual opening 207 as illustrated in FIG. 2B) by using a gaze (direction) vector 206a (of user 203) directed toward a portion of wall 215c intersecting with a line sight of image sensor 228a. In this instance, as user 203 looks toward a target area 236, the virtual opening may fade in gradually. For example, initially the virtual opening may be semi-transparent and when the user’s gaze remains locked on target area 236 for a time period (e.g., few seconds), the virtual opening may fully open up to a fully opaque and accurate view of physical environment 219 as illustrated in FIG. 2B. In some implementations, as the user’s eyes move (or focus shifts), the virtual opening may adapt in real-time to keep a view aligned with a user point of view. Likewise, the virtual opening may automatically adjust a zoom, rotation, or perspective based on a direction of the user's gaze.

In some implementations, a gaze activated triggering mechanism may be enabled for activating a virtual opening (e.g., virtual opening 207 as illustrated in FIG. 2B) by using a gaze (direction) vector 206a (of user 203) and a virtual activation point 229 (or multiple virtual activation points) positioned (e.g., by user 203) at specified locations in XR environment 227. For example, a gaze vector 206a(i.e., a direction of a user's gaze in 3D space) may be projected towards virtual activation point 229 (e.g., invisible or highlighted when in a field of view of user 203). The virtual activation point 229 may be presented as a virtual object (or objects) such as a sphere within XR environment 227. The virtual activation point 229 may have a fixed position or a dynamic position following a line of sight of user 203. Likewise, the virtual activation point 229 may be repositioned within XR environment 227 (e.g., on wall 215c) such that when the gaze vector 206 intersects with virtual activation point 229 (as illustrated in FIG. 2A), it registers as an activation event. Likewise, a fixation time period (e.g., user 203 must look at the virtual activation point 229 for at least one second), may be used to avoid accidental activation events. In some implementations, the gaze activated triggering mechanism may use a use ray-activation point (e.g., sphere) intersection algorithm to: (a) define the activation point 229 by its center position and radius (b) detect when gaze vector 206 intersects activation point 229; and (c) define activation thresholds to avoid false positives (e.g., a fixation duration or alignment).

In some implementations, a virtual opening may be created by enabling user 203 to draw a shape and boundaries of a virtual opening directly on a physical surface (e.g., a wall, desk, or other flat surface) via gestures, a stylus, or a controller in XR environment 227.

In some implementations, visual indicators (e.g., a glowing outline) may be provided to indicate to user positions where a virtual opening may be enabled to appear.

In some implementations, a virtual opening size, shape and orientation may be adjusted. For example, pinch gestures may be used to resize a virtual opening size while rotational gestures or head movement may align a virtual opening size with a specific orientation.

FIG. 2B illustrates view 200b representing XR environment 227 including physical environment 214 with a virtual opening 207 (e.g., a portal) at a first position 217aon wall 215cand aligned with a perspective of the user 203 to provide a view into physical environment 219.

In some implementations, the view provided by virtual opening 207 is created by device 211 reprojecting an image from the image sensor 228a (located in physical environment 219) with respect to a position of user 203. For example, image sensor 228amay be configured to capture image data (in real-time) representing portions of physical environment 219 and the image data may be transformed (e.g., by device 211) to match a current perspective of user 203 as if user 203 (located in physical environment 214) is looking into physical environment 219 through a portal or window within wall 215c.

In some implementations, virtual opening 207 is created via a video reprojection technique that includes the use of three-dimensional (3D) scene reconstruction techniques, depth information, and/or machine learning (ML) based modeling and/or rule-based algorithms to adjust a video feed from image sensor 228a.

In some implementations, a rule-based deterministic approach may be implemented to create virtual opening 207 using predefined rules (e.g., geometric rules, calibrated camera parameters, etc.) for capturing, transforming, and displaying content. For example, a virtual viewing direction of user 203 (within physical environment 214) may be established using tracking data associated with a head/gaze position and orientation of user 203 within physical environment 214 with respect to wall 215c. Likewise, the tracking data may be used to calculate a corresponding virtual viewpoint (of user 203) in physical environment 219 as if user 203 is looking through wall 215c along gaze vector 206a. Accordingly, a position and orientation of user 203 within physical environment 214 may be deterministically mapped to a viewpoint in physical environment 219 using fixed geometric relationships (e.g., offsets, rotation matrices). Subsequently, a video feed from an image sensor (e.g., image sensor 228a) determined to be closest to the user's virtual viewpoint may be directly fed (e.g., in instances where image sensors 228a is oriented along and positioned on gaze vector 206) or reprojected (e.g., using predefined models such as a perspective projection model) to match the virtual viewpoint in instances where image sensor 228 is oriented differently and positioned a distance away from gaze vector 206.

In some implementations, an adjusted video feed may be configured to present a view (e.g., via virtual opening 207) of a portion of physical environment 219 as if user 203 is looking through a physical window into physical environment 219. Likewise, the adjusted video feed may be presented with accurate depth and 3D effects (e.g., parallax).

In some implementations, a 3D scene reconstruction technique may include the use of a camera or a multi-camera setup (e.g., image sensor 228a) within the physical environment 219 to capture a 3D structure of a scene represented in physical environment 219 by converting the scene into a 3D model or point cloud and reprojecting the resulting 3D scene based on a point of view of user 203 with respect to a position for virtual opening 207 and a position or pose of image sensor 228a. For example, image sensor 228a (e.g., an RGB camera) may be configured to capture video frames (representing a scene in physical location 219) with respect to a camera viewpoint (direction) vector 221 and at a specific resolution and frame rate and a monocular depth estimation algorithm may be used to generate a depth map for each frame. The depth map may be combined with intrinsic parameters (focal length, principal point, etc.) of image sensor 228a to generate a 3D point cloud of the scene. Subsequently, a transform or transformation matrix may be calculated based on the user’s viewpoint (e.g., illustrated by gaze vector 206a) with respect to a camera viewpoint (e.g., illustrated by camera viewpoint vector 221). The transformation matrix may include the following chain of transformations: (a) a device 211 to world anchor that includes a dynamic, real-time relationship defining the user’s position and orientation within physical environment 214; (b) a world anchor to room anchor comprising a map defining an alignment of physical environment 219 with respect to physical environment 214; and (c) a room anchor to image sensor 228a pose defining a position and orientation of image sensor 228a (e.g., camera viewpoint (direction) vector 221) within physical environment 219. In some implementations, the transformation matrix converts the 3D point cloud from a perspective of image sensor 228a (e.g., camera viewpoint vector 221) to a perspective of user 203 (gaze vector 206a) and the point cloud is reprojected with respect to the user's viewpoint for final frame rendering.

In some implementations, a point of view of user 203 may be determined based on real-time 3D gaze signals that track where the user 203 is looking with respect to physical environment 214. For example, eye-tracking hardware (e.g., inward facing cameras of device 211) may be configured to capture a gaze direction of user 203 (e.g., gaze vector 206a) by analyzing, inter alia, pupil position, corneal reflections, and head orientation to infer the gaze direction and generate eye tracking data.

In some implementations, physical environment 219 may be mapped in 3D using a depth camera, stereo cameras, and/or simultaneous localization and mapping (SLAM) technology to create a spatial model of the environment, including objects, surfaces, and their locations relative to user 203.

In some implementations, the eye-tracking data may be combined with the spatial model to determine where the user's gaze intersects with physical environment 214 thereby indicating what the user 203 is focusing on in the real world, including its depth and spatial context.

In some instances, an angle between a point of view of user 203 (e.g., gaze vector 206a) and a perspective of image sensor 228a (e.g., camera viewpoint vector 221) may become too steep thereby causing a reprojection on virtual opening 207 to distort a video feed such that visual artifacts are present, a mismatch in lighting or occlusion effects are present, etc. Accordingly, the video feed made be configured to fade out when a threshold angle is exceeded.

In some implementations, a stored model representing physical environment 219 may be used to mitigate distortion caused by a steep angle between a point of view of user 203 (e.g., gaze vector 206a) and a perspective of image sensor 228a (e.g., camera viewpoint vector 221). For example, if user 203 has previously visited physical environment 219 (e.g., within a threshold period of time to ensure relatively recent data) and device 211 has been exposed to its structure, this information may be used to enhance/hole-fill or aid in the reprojection of images from image sensor 228a.

In some implementations, a gaze activated triggering mechanism may be enabled for activating virtual opening 207 by using gaze direction (of user 203) and a virtual activation point as described, supra, with respect to FIG. 2A. For example, a virtual activation point may be placed on a wall between rooms and when user 203 looks at the virtual activation point, gaze vector 206 will intersect with the virtual activation point to activate virtual opening 207.

In some implementations, a servo or robotic means may be used for moving image sensor 228a to align an optical axis of image sensor 228a with a line of sight or gaze of user 203 to accurately reproject content with respect to virtual opening 207. For example, a servo may be used to rotate image sensor to align with a gaze direction of user 203.

In some implementations, multiple image sensors or cameras may be used to capture physical environment 219 from different perspectives. For example, selecting or blending video feeds of multiple image sensors based on viewpoint of user 293 may enable virtual opening 207 to present accurate content as the user's perspective shifts.

In some implementations, content within virtual opening 207 may be scaled towards or away from user 203 to provide zoom and wide angle view capabilities.

In some implementations, virtual opening 207 may be configured to be presented with respect to different shapes and sizes. For example, virtual opening 207 may be circular, rectangular, triangular, panoramic, a 3D floating window, a cloud like structure (e.g., as illustrated in FIG. 2D), any type of specialized shape such as a star or a shape of a person, etc.

FIG. 2C illustrates view 200c representing XR environment 227 including physical environment 214 with virtual opening 207 moved to a second position 217b on wall 215c to provide a different view into physical environment 219. In some implementations, a position of virtual opening 207 may be moved by dragging (e.g., using an input device or gesture input) the virtual opening 207 from first position 217a (as illustrated in FIG. 2B) to second position 217b. In some implementations, a position of virtual opening 207 may be moved via use of gaze activated triggering following a gaze direction such as gaze vector 206b of user 203 intersecting with a virtual activation point as described, supra, with respect to FIGS. 2A and 2B. In some implementations, revealed areas of a virtual opening 207 may remain revealed subsequent to the user 203 looking away. Alternatively, revealed areas of a virtual opening 207 may be removed from a view subsequent to the user 203 looking away.

In some implementations, virtual opening 207 may be configured to provide any size virtual opening. For example, virtual opening 207 may be configured to present a view of physical environment 219 as if the entire wall 215c or a portion of the wall 215c (e.g., larger than virtual opening 207) has been removed. Likewise, virtual opening 207 of any size may be configured to remain static such that it does not move with respect to user gaze.

In some implementations, virtual opening 207 may be configured to reveal any number of regions through the wall 215c in response to dynamic objects within physical environment 219. For example, if two individuals are moving in the physical environment 219 and the user looks at the wall 215c and/or a trigger point (e.g., virtual activation point 229 as illustrated in FIG. 2A), two regions (virtual openings) may be revealed, one for each individual/dynamic object.

In some implementations, user 203 may be enabled to define regions to reveal when looking at the wall 215c. For example, a region that includes a specific type of furniture (e.g., a crib) may always be revealed via a virtual opening regardless of user 203 gaze direction. Likewise, a region associated with a gaze of user 203 may be revealed (via another virtual opening) in combination with the virtual opening associated with the region that includes the specific type of furniture. Therefore, if user 203 looks at wall 215c, a portal around the crib as well as a portal around gaze location that is positioned away from the portal for the crib may be activated and presented to the user 203. Likewise, a portal for the crib may be stationary while a portal for the user gaze may move in accordance with the gaze direction.

FIG. 2D illustrates view 200d representing XR environment 227 including physical environment 214 with a virtual opening 212 comprising a different shape activated at a position 223 on wall 215a to provide a view into another physical environment 218 comprising an image sensor 228b such as, for example, a camera.

In some implementations, a shape of virtual opening 212 may be created by selecting a shape from multiple shape templates.

In some implementations, a shape of virtual opening 212 may be created by enabling user 203 to draw a shape and boundaries of virtual opening 212 directly on a physical surface (e.g., wall 215a) via gestures, a stylus, or a controller in XR environment 227.

In some implementations, a position of virtual opening 212 may be moved by dragging (e.g., using an input device or gesture input) the virtual opening 212 from another position within XR environment 227. In some implementations, virtual opening 207 may be activated via use of gaze activated triggering using a gaze direction of user 203 intersecting with a virtual activation point as described, supra, with respect to FIGS. 2A and 2B.

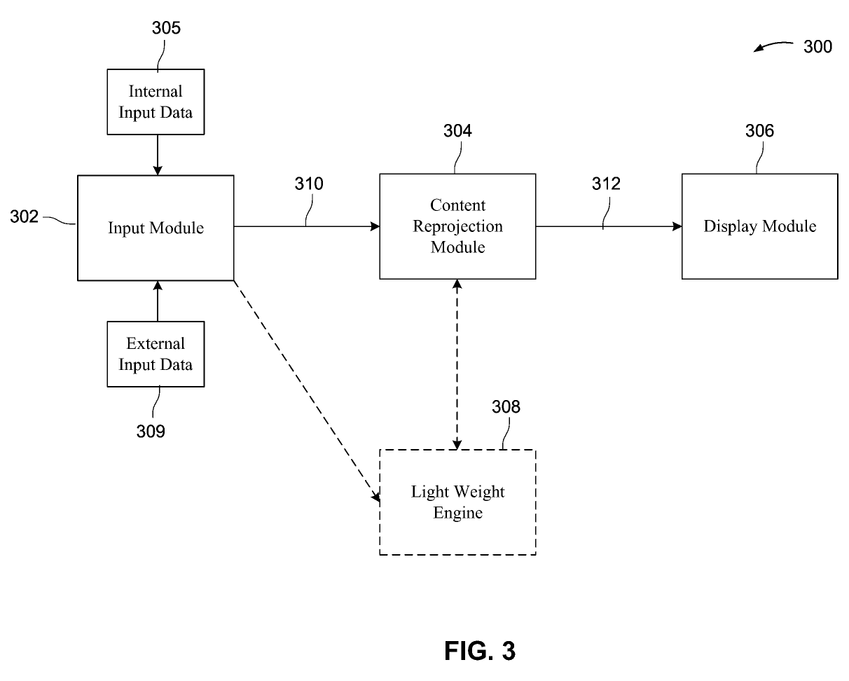

FIG. 3 is a block diagram of an example system illustrating a user device 300 configured to enable a user at a first location (e.g., a first room) to view reprojected content or images from a camera(s) at a second location (e.g., a second adjacent room) from a point of view of the user as if the user is able to see through (e.g., via a portal) an obstacle (e.g., a wall) into the second location. The user device 400 (e.g., an HMD) may include an input module 302, content reprojection module 304, a display module 306, and a light weight engine 308.

In some embodiments, input module 302 is configured to accept internal input data 305 (e.g., internal input data from sensors of the user device 300) associated with user characteristic(s) such as, inter alia, a gaze direction(s), head pose, etc. of a person(s) in a physical environment. For example, internal input data 305 may include images from an inward facing camera of an HMD, etc.

In some embodiments, input module 302 is configured to accept external input data 309 (e.g., external input data from sensors or storage external to user device 300) including a video feed or images, for example, from another location such as an adjacent room.

Inputs 310 from input module 302 can be fed to content reprojection module 304. Content reprojection module 304 can include one or more learning-based and/or non-learning-based models for perceiving, synthesizing, and inferring information. Persons skilled in the art will appreciate that the content reprojection module 304 can include any suitable number of rule-based process(es) to generate output 312 based on input 310.

In some embodiments, content reprojection module 304 may be used in combination with, for example, calibrated camera parameters and fixed geometric relationships that may be used to deterministically map a position and orientation of a user within a first room to a viewpoint of a camera in an adjacent room. In some embodiments, content reprojection module 304 may be used to calculate a transform between a known location of the camera with a current location of the user device 300 and a current gaze direction of a user. This transform will extend from a location and orientation of an external device to a location of the user device 300 and the direction of the gaze.

In some embodiments, user device 300 may optionally elect to use a light weight engine 308 instead of content reprojection module 304 to deterministically map a position and orientation of a user within a first room to a viewpoint in a second room to provide a view (e.g., via a virtual opening such as a portal) of the second room. The light weight engine 308 may be a non-learning network.

In some embodiments, display module 306 is configured to accept results from content reprojection module 304 and/or a light weight engine 308 to deterministically map a position and orientation of a user within a first room to a viewpoint in a second room to provide a view (e.g., via a virtual opening such as a portal) of the second room.

For example, output from content reprojection module 304 and/or a light weight engine 308 is provided to display module 306, where display module 306 provides a view of reprojected content or images from a camera(s) at a second location from a point of view of the user as if the user is able to see through (e.g., via a portal) an obstacle (e.g., a wall) into the second location.

Persons of ordinary skill in the art will appreciate that content reprojection module 304 can include any suitable machine learning models that are well-known or widely available such as regression techniques, classification techniques, neural networks, and deep learning networks. For instance, content reprojection module 304 can include neural networks such as Artificial Neural Network (ANN), Convolutional Neural Network (CNN), Recurrent Neural Network (RNN), Adversarial Network (GAN), Reinforcement Learning Model (RLM), Encoder/Decoder Networks, and/or Transformer-Based Models (e.g., Bidirectional Encoder Representations from Transformers (BERT), Generative Pre-trained Transformer (GPT), and/or a multi-modal large language model (LLM)). Additionally or alternatively, persons of ordinary skill in the art will appreciate that content reprojection module 304 can be any suitable non-learning processes such as rule-based systems, heuristics, decision trees, knowledge-based systems, statistical or stochastic systems, and expert systems.

In instances where content reprojection module 304 is a machine-learning based model, the model may be trained to enable a user in a first physical environment to view reprojected content or images from a camera(s) at physical environment from a point of view of the user as if the user is able to see through (e.g., via a portal) an obstacle (e.g., a wall) into the second physical environment using one or more well-known or widely available training techniques such as supervised learning, semi-supervised learning, unsupervised learning, and/or reinforcement learning techniques. The training data can include images and contextual information.

In some embodiments, content reprojection module 304 can be trained with both synthetic and non-synthetic data.

In some embodiments, content reprojection module 304 can be deployed as one or more generative models, where content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally may include visual content (e.g., images, graphics, and/or video) and/or text content.

In some embodiments, novel automatically-generated content is referred to as generative content (e.g., generative images, generative graphics, generative video, and/or generative text). Generative content is typically generated based on a prompt input 310 to the content reprojection module 304. Input module 302 optionally includes one or more pre-processing steps to adjust the input before it is used by an AI model to generate an output image (e.g., adjustment to a user-provided prompt, creation of a system-generated prompt, and/or AI model selection). Display module 306 optionally includes one or more post-processing steps to adjust the output 312 by the content reprojection module 304 (e.g., passing the AI model output to a different AI model, upscaling, downscaling, cropping, formatting, and/or adding or removing metadata) before the output 312 of the content reprojection module 304 used for other purposes such as being provided to a different software process for further processing or being presented (e.g., visually) to a user.

A prompt input 310 for generating generative content can include one or more of: one or more words (e.g., a natural language prompt that is written or spoken), one or more images, one or more drawings, and/or one or more videos. Generative pre-trained transformer models are a type of LLM that can be effective at generating novel generative content based on a prompt input 310. In some embodiments, the content reprojection module 304 uses a prompt input 310 that includes text to generate either different generative text, generative audio content, and/or generative visual content. In other embodiments, the content reprojection module 304 uses a prompt input 310 that includes visual content and/or an audio content to generate generative text (e.g., a transcription of audio and/or a description of the visual content). In yet other embodiments, the content reprojection module 304 uses a prompt input 310 that includes multiple types of content (e.g., text, images, audio, video, and/or other sensor data) to generate generative content. A prompt input 310 sometimes also includes values for one or more parameters indicating an importance of various parts of the prompt. Some prompt inputs 310 include a structured set of instructions that can be provided to the content reprojection module 304 that include phrasing, a specified style, relevant context (e.g., starting point content and/or one or more examples), and/or a role for the content reprojection module 304.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt input 310 could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt input 310 for creating generative content (e.g., the random or pseudo-random seed content is used as a starting point for creating the generative content). For example, when generating an image from a diffusion model, a random noise pattern is iteratively denoised based on the prompt input 310 to generate an image. While specific types of content reprojection module 304 have been described herein, it should be understood that a variety of different content reprojection module could be used to generate generative content based on a prompt.

In instances where content reprojection module 304 is a non-learning system, non-learning-based content reprojection module 304 can use a pre-defined set of rules or a pre-defined structure to make decisions based on the inputs that the process sees. For example, the content reprojection module 304 can be used to guide a deterministic approach to create a virtual opening using predefined rules (e.g., geometric rules, calibrated camera parameters, etc.) for capturing, transforming, and displaying content. For example, a virtual viewing position of a user may be established using tracking data associated with a gaze/head position and orientation of a user 203 within a first room with respect to a wall. Likewise, the tracking data may be used to calculate a corresponding virtual viewpoint (of the user) in a second adjacent room as if the user is looking through the wall. Accordingly, a position and orientation of the user within the first room may be deterministically mapped to a viewpoint in the second adjacent room using fixed geometric relationships (e.g., offsets, rotation matrices). Subsequently, a video feed from an image sensor (within the second adjacent room) determined to be closest to the user's virtual viewpoint is reprojected (e.g., using predefined models such as a perspective projection model) to match the virtual viewpoint.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in rule-based or machine learning (ML) based process(es) can be used to benefit users. For example, the data can be used to train models that can be deployed to improve performance, accuracy, and/or functionality of applications and/or services. Accordingly, the use of the data enables the rule-based process(es) or ML to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the rule-based process(es) can be used to are also contemplated by the present disclosure.

The present disclosure contemplates that, in some embodiments, data used by the rule-based process(es) can be used to include publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with the rule-based process(es), should attempt to comply with well-established privacy policies and/or privacy practices.

For example, such entities may implement and consistently follow policies and practices recognized as meeting or exceeding industry standards and regulatory requirements for developing and/or training ML-based process(es). In doing so, attempts should be made to ensure all intellectual property rights and privacy considerations are maintained. Training should include practices safeguarding training data, such as personal information, through sufficient protections against misuse or exploitation. Such policies and practices should cover all stages of the process(es) development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, ML-based process(es) may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for content reprojection module 304 may be kept strictly separated from platforms where the content reprojection module 304 are deployed and/or used to interact with users and/or process data. In such embodiments, data used for offline training of the content reprojection module 304 may be maintained in secured datastores with restricted access and/or not be retained beyond the duration necessary for training purposes. In some embodiments, the content reprojection module 304 may utilize a local memory cache to store data temporarily during a user session. The local memory cache may be used to improve performance of the rule-based process(es). However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during ML training and/or use of rule-based process(es). The content reprojection module 304 should be monitored for changes in underlying data distribution such as concept drift or data skew that can degrade performance of the content reprojection module 304 over time.

In some embodiments, the content reprojection module 304 are trained using a combination of offline and online training. Offline training can use curated datasets to establish baseline model performance, while online training can allow the content reprojection module 304 to continually adapt and/or improve. The present disclosure recognizes the importance of maintaining strict data governance practices throughout this process to ensure user privacy is protected.

In some embodiments, the content reprojection module 304 processes may be designed with safeguards to maintain adherence to originally intended purposes, even as the content reprojection module 304 adapt based on new data. Any significant changes in data collection and/or applications of content reprojection module 304 use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the content reprojection module 304 and/or for use as input during the inference stage of such systems. In yet another example, the present technology should be configured to allow users to be able to select to limit the length of time data is maintained or entirely prohibit the use of their data for use by the rule-based process(es). In addition to providing “opt in” and “opt out” options, the present disclosure contemplates providing notifications relating to the access or use of personal information. For instance, a user can be notified when their data is being input into the content reprojection module 304 for training or inference purposes, and/or reminded when the content reprojection module 304 generate outputs or make decisions based on their data.

The present disclosure recognizes content reprojection module 304 should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the rule-based process(es). Generated content can be filtered for potentially inappropriate or dangerous material prior to being presented to users, while human oversight and/or ability to override or correct erroneous or undesirable outputs can be maintained as a failsafe.

The present disclosure further contemplates that users of the content reprojection module 304 should refrain from using the services in any manner that infringes upon, misappropriates, or violates the rights of any party. Furthermore, the content reprojection module 304 should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The content reprojection module 304 should not violate, misappropriate, or infringe any copyrights, trademarks, rights of privacy and publicity, trade secrets, patents, or other proprietary or legal rights of any party, and appropriately attribute content as required. Further, the content reprojection module 304 should not interfere with any security, digital signing, digital rights management, content protection, verification, or authentication mechanisms. The content reprojection module 304 should not misrepresent machine-generated outputs as being human-generated.

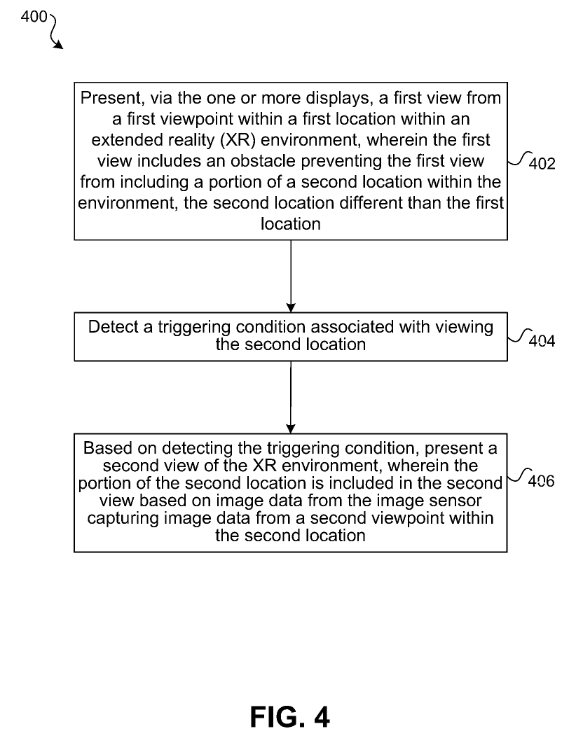

FIG. 4 is a flowchart representation of an exemplary method 400 that enables a user at a first location to view from a point of view of the user, reprojected content or images from a camera(s) at a second location as if the user is able to see through an obstacle into the second location, in accordance with some implementations. In some implementations, the method 400 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 presents a first view from a first viewpoint of a device such as an HMD within a first location within an environment. The first view includes an obstacle preventing the first view from including a portion of a second location (e.g., differing from and adjacent to the first location) within the environment. For example, a user 203 wearing a device 211 may be located within a physical environment 214 and a wall 215c may create an obstacle with respect to viewing (by user 203) content within a physical environment 219 as illustrated in FIG. 2A.

At block 404, the method 400 detects a triggering condition associated with viewing the second location. For example, a gaze activated triggering mechanism may be enabled for activating a virtual opening by using a gaze vector 206 (of user 203) and a virtual activation point 229 positioned (e.g., by user 203) at specified locations in an XR environment 227 as described with respect to FIG. 2A.

In some implementations, detecting the triggering condition associated with viewing the second location includes determining that the user is looking towards the second location.

In some implementations, detecting the triggering condition associated with viewing the second location includes detecting that the user moves a virtual portal structure to a viewing location (e.g., on a wall) in the XR environment.

In some implementations, detecting the triggering condition associated with viewing the second location includes detecting a user gesture such as gaze and/or a hand or finger gesture directed towards the second location.

In some implementations, detecting the triggering condition associated with viewing the second location may be detected via sensor data obtained from a sensor.

At block 406, the method 400 (based on detecting the triggering condition) presents a second view of the environment. The portion of the second location may be included in the second view based on image data from the image sensor capturing image data from a second viewpoint within the second location. For example, a virtual opening 207 (e.g., a portal) may be activated at a first position 217a on wall 215c and aligned with a perspective of a user 203 to provide a view into a physical environment 219 as described with respect to FIG. 2B. In some implementations, the second view of the environment may include the first view of the environment and a portion of the second location. In some implementations, the portion of the second location may be reprojected to a point of view of the user along a gaze direction.

In some implementations, method 400 determines that an alignment criterion is satisfied based on an orientation of an image sensor capable of capturing image data from a second viewpoint within the second location. For example, an angular difference between device 105 or 110 direction and a camera capture direction may be less than a threshold angular difference as described with respect to FIG. 2A. In some implementations, presenting the second view of the environment may be further based on the alignment criterion.

In some implementations, determining that the alignment criterion may be satisfied is further based on the orientation of the image sensor being aligned with an orientation of the electronic device. In some implementations, the orientation of the image sensor may be aligned with the orientation of the electronic device by moving a position of the image sensor. In some implementations, the position of the image sensor may be moved via use of an electromechanical device such as, for example, a servo, a robotic device, etc. In some implementations, an angle between the orientation of the image sensor and the orientation of the electronic device may be less than a threshold angle.

In some implementations, a transform may be calculated between an image captured by an external camera with respect to a point of view of the user along a gaze direction. This transform may extend from a location and orientation of the external device to a location of a user device and a direction of user gaze. The transform may be calculated in response to determining that the alignment criterion is satisfied.

In some implementations, presenting the second view of the XR environment may include replacing a portion of the obstacle with content obtained from the image sensor within the second location.

In some implementations, the content obtained from the image sensor within the second location may include altered content providing the second view with respect to the first viewpoint.

In some implementations, presenting the second view may include providing a virtual opening within the obstacle through which the second location is viewed.

In some implementations, the virtual opening may be provided instantaneously in response to the triggering condition and determining that the alignment criterion is satisfied.

In some implementations, the virtual opening may be provided over a specified timeframe (e.g., a portal slowly opens) in response to the triggering condition (e.g., gaze) and determining that the alignment criterion is satisfied.

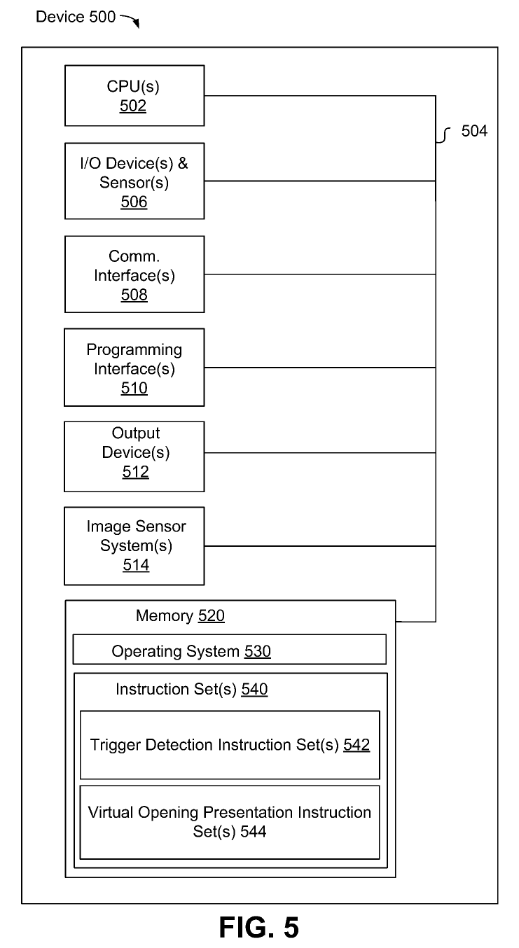

FIG. 5 is a block diagram of an example device 500. Device 500 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a trigger detection instruction set 542 and a virtual opening presentation set 544. The instruction set(s) 540 may be embodied as a single software executable or multiple software executables.

The trigger detection instruction set 542 is configured with instructions executable by a processor to detect a triggering condition associated with viewing another location obscured by an obstacle. For example, a triggering condition may include determining that a user is looking towards the other location, detecting that the user drags a portal to a viewing location (on a wall) in an XR environment, etc.

The virtual opening presentation instruction set 544 is configured with instructions executable by a processor to provide an opening or portal in the obstacle (e.g., wall) through which the other location may be viewed.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor and one or more displays:
presenting, via the one or more displays, a first view from a first viewpoint within a first location within an environment, wherein the first view includes an obstacle preventing the first view from including a portion of a second location within the environment, the second location different than the first location;
detecting a triggering condition associated with viewing the second location; and
based on detecting the triggering condition, presenting a second view of the environment, wherein the portion of the second location is included in the second view based on image data from an image sensor capturing image data from a second viewpoint within the second location.

2. The method of claim 1, wherein detecting the triggering condition associated with viewing the second location comprises determining that the user is looking towards the second location.

3. The method of claim 1, wherein detecting the triggering condition associated with viewing the second location comprises detecting that the user moves a virtual portal structure to a viewing location in the XR environment.

4. The method of claim 1, wherein detecting the triggering condition associated with viewing the second location comprises detecting a user gesture.

5. The method of claim 1, wherein detecting the triggering condition associated with viewing the second location comprises detecting that a gaze vector intersects with a virtual activation point at a viewing location in the XR environment.

6. The method of claim 1, further comprising:
determining that an alignment criterion is satisfied based on an orientation of the image sensor capturing the image data from the second viewpoint within the second location, wherein presenting the second view of the environment is further based on the alignment criterion.

7. The method of claim 6, wherein determining that the alignment criterion is satisfied is further based on the orientation of the image sensor being aligned with an orientation of the electronic device.

8. The method of claim 7, wherein the orientation of the image sensor is aligned with the orientation of the electronic device by moving a position of the image sensor.

9. The method of claim 8, wherein the position of the image sensor is moved via use of an electromechanical device.

10. The method of claim 6, wherein an angle between the orientation of the image sensor and the orientation of the electronic device is less than a threshold angle.

11. The method of claim 1, wherein presenting the second view of the environment comprises replacing a portion of the obstacle with content obtained from the image sensor within the second location.

12. The method of claim 11, wherein the content obtained from the image sensor within the second location comprises altered content providing the second view with respect to the first viewpoint.

13. The method of claim 1, wherein presenting the second view comprises providing a virtual opening within the obstacle through which the second location is viewed.

14. The method of claim 13, wherein the virtual opening is provided instantaneously in response to the triggering condition and said determining that the alignment criterion is satisfied.

15. The method of claim 13, wherein the virtual opening is provided over a specified timeframe in response to the triggering condition and said determining that the alignment criterion is satisfied.

16. A non-transitory computer-readable medium comprising instructions that when executed by a processor cause the processor to perform operations comprising:
presenting, via one or more displays, a first view from a first viewpoint within a first location within an environment, wherein the first view includes an obstacle preventing the first view from including a portion of a second location within the environment, the second location different than the first location;
detecting a triggering condition associated with viewing the second location; and
based on detecting the triggering condition, presenting a second view of the environment, wherein the portion of the second location is included in the second view based on image data from an image sensor capturing image data from a second viewpoint within the second location.

17. An electronic device comprising:
one or more displays;
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
presenting, via the one or more displays, a first view from a first viewpoint within a first location within an environment, wherein the first view includes an obstacle preventing the first view from including a portion of a second location within the environment, the second location different than the first location;
detecting a triggering condition associated with viewing the second location; and
based on detecting the triggering condition, presenting a second view of the environment, wherein the portion of the second location is included in the second view based on image data from an image sensor capturing image data from a second viewpoint within the second location.

18. The electronic device of claim 17, wherein detecting the triggering condition associated with viewing the second location comprises determining that the user is looking towards the second location.

19. The electronic device of claim 17, wherein detecting the triggering condition associated with viewing the second location comprises detecting that the user moves a virtual portal structure to a viewing location in the XR environment.

20. The electronic device of claim 17, wherein detecting the triggering condition associated with viewing the second location comprises detecting a user gesture.
